(19) United States
(12) Patent Application Publication
(10) Pub. No.: US 2014/0168768 A1
(43) Pub. Date: Jun. 19, 2014

(54) POLARIZING PLATE AND OPTICAL DISPLAY APPARATUS INCLUDING THE SAME

(71) Applicant: CHEIL INDUSTRIES INC., Gumi-si (KR)

(72) Inventors: Eun Kyeong Seo, Uiwang-si (KR); Mun Bo Ko, Uiwang-si (KR); Min Jung Kim, Uiwang-si (KR); Yong Woon Kim, Uiwang-si (KR); Ki Ho Park, Uiwang-si (KR); Jung Kyu Lee, Uiwang-si (KR)

(73) Assignee: CHEIL INDUSTRIES INC., Gumi-si (KR)

(21) Appl. No.: 14/106,273

(22) Filed: Dec. 13, 2013

(30) Foreign Application Priority Data
Dec. 14, 2012 (KR) 10-2012-0146545

(51) Int. Cl. G02B 5/30

(52) U.S. Cl. CPC G02B 5/3083
USPC 359/489.07

(57) ABSTRACT

A polarizing plate includes a polarizer, a protective film on an upper surface of the polarizer, a half-wavelength (λ/2) retardation film on a lower surface of the polarizer, an adhesive layer on a lower surface of the half-wavelength (λ/2) retardation film, and a quarter-wavelength (λ/4) retardation film on a lower surface of the adhesive layer. The half-wavelength (λ/2) retardation film may have a refractive index n1, the quarter-wavelength (λ/4) retardation film may have a refractive index n2, and the adhesive layer may have a refractive index n in the range of n1<n<n2 or n2<n<n1. An optical display apparatus may include the polarizing plate, and further a window on a top surface of the polarizing plate, a conductor on a bottom surface of the polarizing plate, an optical display device on a bottom surface of the conductor, and a substrate on a bottom surface of the optical display device.

### CROSS-REFERENCE TO RELATED APPLICATION

This application claims priority to and the benefit of Korean Patent Application No. 10-2012-0146545, filed on Dec. 14, 2012, in the Korean Intellectual Property Office, the entire disclosure of which is incorporated herein by reference.

### BACKGROUND

1. Field

Aspects of the present invention relate to a polarizing plate and an optical display apparatus including the same.

2. Description of the Related Art

An organic light emitting diode (OLED) display refers to a self-luminous display that emits light through electrical excitation of fluorescent organic compounds. Such a display apparatus has advantages, including operability at a lower voltage, reduced thickness, etc. In addition, OLED display apparatuses overcome many of the problems associated with typical liquid crystal display apparatuses, providing broader viewing angles, faster response times, etc., and have thus attracted much attention in recent years.

Generally, an OLED display apparatus includes a glass substrate, an organic electroluminescent section located on the glass substrate, and a protecting encapsulating cap surrounding the organic electroluminescent section having water-resisting properties. Unlike liquid crystal displays, OLED displays do not require a polarizing plate for enabling a display on the display screen due to self-luminescence characteristics thereof. However, in order to compensate for deterioration in brightness due to reflection of external light by an Aluminum plate of an OLED driving panel, an OLED display generally does include a polarizing plate. This polarizing plate of an OLED display is typically located on an upper side of the glass substrate.

Typically, a polarizing plate including a quarter-wavelength (λ/4) retardation film is used with OLED display apparatuses in the art. However, a polarizing plate capable of enabling circular polarization using only a single λ/4 retardation film often encounters problems including low lateral reflective visibility and insufficient prevention of reflection of external light.

### SUMMARY

Embodiments of the present invention relate to a polarizing plate and an optical display apparatus including a polarizing plate.

According to an aspect of the present invention, a polarizing plate may include a polarizer, a protective film on an upper surface of the polarizer, a half-wavelength (λ/2) retardation film on a lower surface of the polarizer, an adhesive layer on a lower surface of the half-wavelength (λ/2) retardation film, and a quarter-wavelength (λ/4) retardation film on a lower surface of the adhesive layer. The half-wavelength (λ/2) retardation film may have a refractive index n1, the λ/4 retardation film may have a refractive index n2, and the adhesive layer may have a refractive index n in the range of n1<n<n2 or n2<n<n1.

The half-wavelength (λ/2) and quarter-wavelength (λ/4) retardation films of the polarizing plate may include birefringences of opposite signs.

The half-wavelength (λ/2) retardation film of the polarizing plate may have a positive (+) birefringence, and the quarter-wavelength (λ/4) retardation film may have a negative (−) birefringence.

The refractive index of the half-wavelength (λ/2) retardation film n1 may range from approximately 1.50 to approximately 1.55, and the refractive index of the quarter-wavelength (λ/4) retardation film n2 may range from approximately 1.45 to approximately 1.55.

The refractive index of the adhesive layer n may range from approximately 1.46 to approximately 1.52

Each of the half-wavelength (λ/2) and quarter-wavelength (λ/4) retardation films may have a phase difference ranging from approximately 0 nanometers to approximately 300 nanometers at a wavelength of 550 nanometers.

The half-wavelength (λ/2) retardation film of the polarization plate may have an out-of-plane retardation ranging from approximately 220 nanometers to approximately 240 nanometers at a wavelength of 550 nanometers, and the quarter-wavelength (λ/4) retardation film may have an out-of-plane retardation ranging from approximately −100 nanometers to approximately −130 nanometers at a wavelength of 550 nanometers. The out-of-plane retardation (Rth) may be calculated using the formula Rth=((nx+ny)/2−nz)×d, where nx, ny, and nz are refractive indexes in x-, y-, and z-axis directions of each retardation film, and d is a thickness of the retardation film.

The half-wavelength (λ/2) and quarter-wavelength (λ/4) retardation films each may include a cycloolefin polymer (COP), acrylic, and/or cellulose film.

A relationship between an angle of an optical axis of the half-wavelength (λ/2) and an angle of an optical axis of the quarter-wavelength (λ/4) retardation films of the polarizing plate may be calculated using the formula θ_{λ/4}=2×θ_{λ/2}+45°, wherein θ_{λ/4} is an angle of an optical axis of the quarter-wavelength (λ/4) retardation film, θ_{λ/2} is an optical axis of the half-wavelength (λ/2) retardation film, and the angles θ_{λ/2} and θ_{λ/4} are measured from a point of reference such as an absorption axis or a transmission axis of the polarizer.

Each of the half-wavelength (λ/2) and quarter-wavelength (λ/4) retardation films of the polarizing plate may have a thickness ranging from approximately 10 micrometers to approximately 100 micrometers.

The adhesive layer of the polarizing plate may include a (meth)acrylic copolymer resin and a curing agent.

The polarizing plate may further include a functional layer on an upper surface of the protective film. The functional layer may include a hard coating layer.

The polarizing plate may further include an adhesive layer having a refractive index ranging from approximately 1.48 to approximately 1.55 on a lower surface of the quarter-wavelength (λ/4) retardation film.

In accordance with another aspect of the present invention, a polarizing plate may include a polarizer, a protective film on an upper surface of the polarizer, a half-wavelength (λ/2) retardation film on a lower surface of the polarizer, and a quarter-wavelength (λ/4) retardation film on a lower surface of the half-wavelength (λ/2) retardation film. The half-wavelength (λ/2) and quarter-wavelength (λ/4) retardation films may include birefringences of opposite signs.

The polarizing plate may further include an adhesive layer between the half-wavelength (λ/2) retardation film and the quarter-wavelength (λ/4) retardation film.

The half-wavelength (λ/2) retardation film of the polarizing plate may have a refractive index n1, the quarter-wavelength (λ/4) retardation film may a have refractive index n2, and the adhesive layer may have a refractive index n in the range of n1<n<n2 or n2<n<n1.

In accordance with a further aspect of the present invention, an optical display apparatus includes a polarizing plate, a window on a top surface of the polarizing plate, a conductor on a bottom surface of the polarizing plate, an optical display device on a bottom surface of the conductor, and a substrate on a bottom surface of the optical display device. The polarizing plate may include a polarizer, a half-wavelength (λ/2) retardation film on a lower surface of the polarizer, and a quarter-wavelength (λ/4) retardation film on a lower surface of the half-wavelength (λ/2) retardation film.

The optical display apparatus may be an organic light emitting diode (OLED) display apparatus.

The polarizing plate of the optical display apparatus may include a protective film on an upper surface of the polarizer, and an adhesive layer on a lower surface of the half-wavelength (λ/2) retardation film. The half-wavelength (λ/2) retardation film may have a refractive index n1, the quarter-wavelength (λ/4) retardation film may have a refractive index n2, and the adhesive layer may have a refractive index n in the range of n1<n<n2 or n2<n<n1.

### BRIEF DESCRIPTION OF THE DRAWINGS

The above and other aspects, features, and advantages of the invention will become apparent from the detailed description of the following embodiments given in conjunction with the accompanying drawings, in which:

FIG. 1 is a cross-sectional view of a polarizing plate according to an embodiment of the present invention;

FIG. 2 is a schematic perspective diagram of a retardation film according to an embodiment of the present invention; and

FIG. 3 is a cross-sectional view of an organic light emitting diode (OLED) display apparatus according to an embodiment of the present invention.

### DETAILED DESCRIPTION

Embodiments of the present invention will be described in detail with reference to the accompanying drawings. It should be understood that aspects of the present invention may be embodied in different ways and are not limited to the following embodiments. In the drawings, portions not relevant to the description will be omitted for clarity. Like components will be denoted by like reference numerals throughout the specification. As used herein, terms such as “upper side” or “upper surface” and “lower side” or “lower surface” are defined with reference to the accompanying drawings. Thus, it will be understood that the term “upper side” or “upper surface” can be used interchangeably with the term “lower side” or “lower surface.”

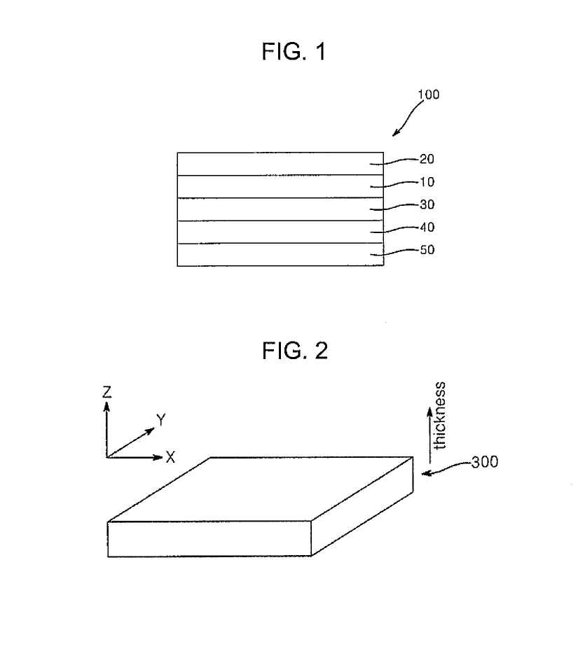

Hereinafter, a polarizing plate according to one embodiment of the present invention will be described in detail with reference to FIG. 1, which is a cross-sectional view of a polarizing plate according to an embodiment of the present invention.

Referring to FIG. 1, a polarizing plate 100 according to one embodiment of the invention may include: a polarizer 10; a protective film 20 positioned on an upper surface of the polarizer 10; a half-wavelength or λ/2 retardation film 30 positioned on a lower surface of the polarizer 10; an adhesive layer 40 positioned on a lower surface of the λ/2 retardation film 30; and a quarter-wavelength or λ/4 retardation film 50 positioned on a lower surface of the adhesive layer 40, wherein, when the λ/2 retardation film 30 has a refractive index n1, the λ/4 retardation film 50 has a refractive index n2, and the adhesive layer 40 has a refractive index n ranging between n1 and n2. As a result, the polarizing plate 100 may prevent deterioration of optical properties due to a difference in refractive index resulting from using these two different types of retardation films while also preventing deterioration of front visibility and lateral brightness as a result of stacking the λ/2 and λ/4 retardation films 30 and 50.

Specifically, when the λ/2 and λ/4 retardation films 30 and 50 have refractive indexes n1 and n2, respectively, the adhesive layer 40 may have a refractive index n in the range of n1<n<n2 or n2<n<n1.

The polarizer 10 may be formed of a polyvinyl alcohol resin, and may include any polyvinyl alcohol resin typically used in the art. Specifically, the polarizer 10 may be a linear polarizer, which absorbs linearly polarized light having an oscillation plane of a specific direction and transmits linearly polarized light having an oscillation plane direction orthogonal thereto by adsorption and alignment of a dichroic material to a polyvinyl alcohol resin. The dichroic material may be iodine or a dichroic organic dye.

A polarizer 10 according to an embodiment of the present invention may be formed by uniaxial elongation of a polyvinyl alcohol resin film, followed by dyeing the polyvinyl alcohol resin film with a dichroic material and treating it with a boric acid treatment.

The polarizer 10 may have a thickness ranging from approximately 20 micrometers (μm) to approximately 30 μm. Within this range, the polarizer 10 may be used with an optical display apparatus.

The polarizer 10 may be stacked between the protective film 20 and the λ/2 retardation film 30 via a bonding layer. The bonding layer may be formed of a bonding agent configured for polarizing plates, and more specifically, the bonding agent may be a water-based bonding agent or a pressure-sensitive bonding agent. The bonding layer may have a thickness ranging from approximately 10 nanometers (nm) to approximately 20 nm.

According to an embodiment, the protective film 20 is a transparent protective layer positioned on one surface of the polarizer 10 and may be configured to protect the polarizer 10.

In this embodiment, protective film 20 has a thickness ranging from approximately 20 μm to approximately 1,000 μm. In an embodiment, the protective film 20 has a thickness ranging from approximately 40 μm to approximately 80 μm. Within this range, the protective film 20 may be included as part of the polarizing plate 100 when stacked on the polarizer 10.

The protective film 20 may be any type of protective film typically used in the art as a protective layer for a polarizer 10. The protective film 20 may include at least one of a cellulose, polyester, cyclic polyolefin, polycarbonate, polyethersulfone (PES), polysulfone (PSU), polyimide, polyimide, polyolefin, polyacrylate, polyvinyl alcohol, polyvinyl chloride, or polyvinylidene chloride film.

The polarizing plate 100 may include a functional layer on upper side of the protective film 20. The functional layer may be a hard coating layer, or other similar functional layer types. In one embodiment, the functional layer may have a thickness from approximately 10 μm to approximately 50 μm.

The retardation film 30 and/or 50 may adjust the phase difference or improve the viewing angle by adjusting optical properties. According to one embodiment, the polarizing plate 100 may include both the λ/2 and μ/4 retardation films 30 and 50. As a result, the polarizing plate 100 can overcome problems relating to low lateral reflective visibility and insufficient reflection prevention, which occur in polarizing plates 100 including circular polarization using only a single λ/4 retardation film 50.

The λ/2 and λ/4 retardation films 30 and 50 may be configured to convert linearly polarized light into circularly polarized light or to convert circularly polarized light into linearly polarized light by imparting a phase difference between the λ/2 and λ/4 retardation films 30 or 50 to two components of polarized light which are parallel to an optical axis of the retardation film 30 or 50 and orthogonal to each other. In an embodiment, the retardation film 30 or 50 converts internal light emitted from an organic light emitting diode (OLED) display from circularly polarized light into linearly polarized light, or converts external light coming from an exterior of the display from linearly polarized light into circularly polarized light.

The λ/2 and λ/4 retardation films 30 and 50 may have birefringences of opposite signs. For example, the λ/2 retardation film 30 may have a positive birefringence and the λ/4 retardation film 50 may have a negative birefringence, or the λ/2 retardation film 30 may have a negative birefringence and the λ/4 retardation film 50 may have a positive birefringence. As a result, the polarizing plate 100 may exhibit improved compensation of a lateral viewing angle through cancellation of out-of-plane retardation (Rth).

As used herein, the term “positive birefringence” means that, when fight is incident upon a uniaxially aligned film, a refractive index of the light in the alignment direction is greater than that in an orthogonal direction thereto, and the term “negative birefringence” means that, when light is incident upon the uniaxially aligned film, the refractive index of the light in the alignment direction is less than that in the orthogonal direction thereto.

The λ/2 and λ/4 retardation films 30 and 50 may have a phase difference (Re) ranging from approximately 0 nm to approximately 300 nm at a wavelength of 550 nm. Within this range, the polarizing plate 100 may prevent a deterioration in lateral reflective visibility.

For the λ/2 and λ/4 retardation films 30 and 50 at a wavelength of 550 nm, in-plane retardation (Re), out-of-plane retardation (Rth), and a degree of biaxiality (Nz) may be respectively represented by Equations 1 through 3, below:

Re=(nx−ny)×d Equation 1

Rth=((nx+ny)/2−nz)×d Equation 2

Nz=(nx−nz)/(nx−ny) Equation 3

wherein nx, ny, and nz are the refractive index in x-, y-, and z-axis directions, respectively, of the retardation film 30 or 50, and d is a thickness of the retardation film 30 or 50 in nanometers (nm).

FIG. 2 is a schematic perspective diagram of a retardation film according to an embodiment of the present invention. Referring to FIG. 2, a retardation film 300 may have an x-axis direction corresponding to a length of the retardation film 300 (MD direction), a y-axis direction corresponding to a width of the retardation film 300 (TD direction), a z-axis direction corresponding to a thickness of the retardation film 300, wherein the x-axis, y-axis and z-axis are orthogonal each other.

The phase difference (Re) between the respective λ/2 and λ/4 retardation films 30 and 50 is configured for formation of circularly polarized light at a wavelength of 550 nm.

In one embodiment, the λ/2 retardation film 30 may have an in-plane retardation (Re) ranging from approximately 250 nm to approximately 280 nm, an out-of-plane retardation (Rth) ranging from approximately 220 nm to approximately 240 nm, and a degree of biaxiality (Nz) ranging from approximately 1.52 to approximately 1.54, at a wavelength of 550 nm. In another embodiment, the λ/4 retardation film 50 may have an in-plane retardation (Re) ranging from approximately 130 nm to approximately 150 nm, an out-of-plane retardation (Rth) ranging from approximately −100 nm to approximately −130 nm, and a degree of biaxiality (Nz) ranging from approximately 1.48 to approximately 1.50, at a wavelength of 550 nm.

The λ/2 and λ/4 retardation films 30 and 50 may include any film typically used in the art for a polarizing plate having a phase retardation function. For example, the λ/2 and λ/4 retardation films 30 and 50 may be prepared from olefin films including cycloolefin polymer (COP) films, acrylic films, cellulose films, or mixtures thereof. In an embodiment, the λ/2 retardation film 30 is an olefin film and the λ/4 retardation film 50 is an acrylic film.

Each of the retardation films 30 and 50 may have a thickness ranging from approximately 10 μm to approximately 100 μm. Within this range, the retardation films 30 and 50 may provide optical compensation and circular polarization when used in the polarizing plate 100. In another embodiment, each of the retardation films 30 and 50 has a thickness ranging from approximately 10 μm to approximately 60 μm.

In one embodiment, the λ/2 retardation film 30 may have a thickness ranging from approximately 40 μm to approximately 50 μm and the λ/4 retardation film 50 may have a thickness ranging from approximately 45 μm to approximately 55 μm.

A polarizing plate 100 including circular polarization using only a single λ/4 retardation film 50 may result in insufficient reflection prevention resulting from low lateral reflective visibility. To overcome this type of problem, the λ/2 and λ/4 retardation films 30 and 50 may be combined at a specific angle. In one embodiment, the λ/2 and λ/4 retardation films 30 and 50 may be positioned in a relationship defined by the following equation: θ_{λ/4}=2×θ_{λ/2}+45°. Here, where θ_{λ/4} represents an angle of an optical axis of the λ/4 retardation film 50 with regard to a reference, and θ_{λ/2} represents an optical axis of the λ/2 retardation 30 film with regard to the reference, wherein the reference may be an absorption axis or a transmission axis of the polarizer 10.

The λ/2 and λ/4 retardation films 30 and 50 may be bonded to each other via an adhesive layer 40. In embodiments where the polarizing plate 100 includes both λ/2 and λ/4 retardation films 30 and 50 having different refractive indexes, the optical properties of the polarizing plate 100 may be deteriorated. Thus, to overcome this potential deterioration, an adhesive layer 40, which bonds the λ/2 and λ/4 retardation films 30 and 50 to each other, may have an adjusted refractive index.

In embodiments where the λ/2 and λ/4 retardation films 30 and 50 have refractive indexes n1 and n2, respectively, the adhesive layer 40 may have a refractive index n in the range of n1<n<n2 or n2<n<n1. Specifically, n1 and n2 may vary depending on the materials of the retardation films 30 and 50, and n1 may range from approximately 1.50 to approximately 1.55, for example approximately 1.50, 1.51, 1.52, 1.53, 1.54, or 1.55 and n2 may range from approximately 1.45 to about 1.55, for example approximately 1.45, 1.46, 1.47, 1.48, 1.49, 1.50, 1.51, 1.52, 1.53, 1.54, or 1.55.

In one embodiment where n1 is 1.53 and n2 is 1.45, n may be in the range of 1.45<n<1.53. In an embodiment, n ranges from approximately 1.46 to approximately 1.52; and, in anther embodiment n rangers from approximately 1.47 to approximately 1.52, for example approximately 1.46, 1.47, 1.48, 1.49, 1.50, 1.51, or 1.52.

The adhesive layer 40 may be formed using typical adhesives known in the art, including, for example, an adhesive including a (meth)acrylic copolymer as an adhesive resin and a curing agent, or a pressure-sensitive adhesive (PSA). The refractive index of the adhesive layer 40 may be adjusted using typical methods. For example, the refractive index of the adhesive layer 40 may be changed by adjusting a ratio and components of (meth)acrylic monomers included in the (meth)acrylic copolymer, the content of a curing agent included in the adhesive, etc. For example, the (meth)acrylic copolymer may be polymerized for a monomer mixture comprising at least one of a (meth)acrylic monomer including an alkyl group, a (meth)acrylic monomer including a hydroxyl group, a (meth)acrylic monomer including an alicyclic group, a (meth)acrylic monomer including a hetero-alicyclic group and a (meth)acrylic monomer including a carboxylic acid, or a (meth)acrylic monomer including an aromatic group, as known in the art. For example, the monomer mixture may comprise the (meth)acrylic monomer including an alkyl group of approximately 60 to 99 wt %, the (meth)acrylic monomer including a hydroxyl group of approximately 0 to 5 wt %, the (meth)acrylic monomer including an alicyclic group of approximately 0 to 5 wt %, the (meth)acrylic monomer including a hetero-alicyclic group of approximately 0 to 5 wt %, the (meth)acrylic monomer including a carboxylic acid of approximately 0 to 5 wt %, or the (meth)acrylic monomer including aromatic group of approximately 1 to 30 wt %. The curing agent may be an isocyanate curing agent used at approximately 0.1 to 5 wt % based on the (meth)acrylic copolymer 100 wt % by weight.

The adhesive may have a glass transition temperature (Tg) ranging from approximately −50° C. to approximately −40° C., for example approximately −50° C., −49° C., −48° C., −47° C., −46° C., −45° C., −44° C., −43° C., −42° C., −41° C., or −40° C. Within this range, the adhesive may be applied to the adhesive layer 40. The adhesive layer 40 may have a thickness ranging from approximately 10 μm to approximately 20 μm. Within this range, the polarizing plate 100 may be included in an optical display apparatus.

The polarizing plate 100 may have a thickness from about 120 μm to about 170 μm. The polarizing plate 100 can be applied to a liquid crystal display apparatus.

The polarizing plate 100 may be stacked on an OLED panel or a similar apparatus via a second adhesive layer. The second adhesive layer may be formed of an adhesive, which may be selected from any adhesive capable of exhibiting transparency, durability, reworkability, etc., as required for adhesives of optical films. For example, the adhesive may be an adhesive including a (meth)acrylic copolymer adhesive resin. Here, the “second adhesive layer” may be distinguished from the first adhesive layer 40 in that the adhesive layer 40 formed between the λ/2 and λ/4 retardation films 30 and 50 is referred to as the first adhesive layer 40.

The second adhesive layer may have a refractive index, which varies in range, for example, from approximately 1.48 to approximately 1.55, for example approximately 1.48, 1.49, 1.50, 1.51, 1.52, 1.53, 1.54 or 1.55, depending upon the refractive index of the adhesive layer.

The second adhesive layer may have a thickness ranging from approximately 10 μm to approximately 20 μm. Within this range, the polarizing plate 100 may be included in the optical display apparatus.

According to one embodiment, an optical display apparatus may include the polarizing plate 100. The optical display apparatus may include an organic light emitting diode (OLED) display apparatus, without being limited thereto.

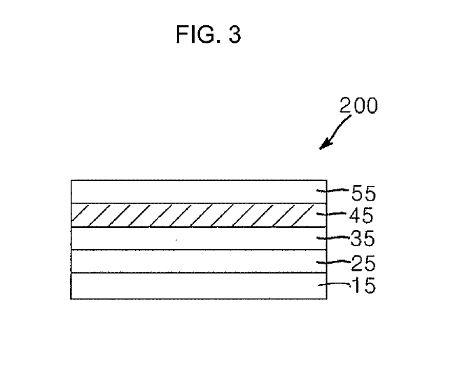

FIG. 3 is a cross-sectional view of an organic light emitting diode (OLED) display apparatus according to one embodiment of the present invention. Referring to FIG. 3, an organic light emitting diode (OLED) display apparatus 200 according to an embodiment of the present invention may include a substrate 15; a device 25 for an OLED 200 positioned on the substrate 15; a transparent conductor 35 positioned on the device 25; a polarizing plate 45 positioned on the transparent conductor 35; and a window 55 positioned on the polarizing plate 45, wherein the polarizing plate 45 may include the polarizing plate 100 according to the embodiment described with respect to FIG. 1.

Hereinafter, aspects of the present invention will be described in more detail with reference to some examples. However, it should be noted that these examples are provided for purposes of illustration only, and are not to be construed in any way as limiting the present invention. In the examples, the following materials were used for each of the components of the OLED display apparatus described below.

(1) Polarizer: Polyvinyl alcohol film (PS60, Kuraray Co., Ltd., Japan, thickness: 60 μm).

(2) Protective film: HC TAC (KONICA Co., Ltd., Japan, thickness: 47 μm).

(3) λ/2 retardation film: Cycloolefin polymer (COP) film (ZEON Co., Ltd., Japan, with a wavelength of 550 nm, Re: 250 nm to 280 nm, Rth: 220 nm to 240 nm, Nz: 1.52 to 1.54, thickness: 40 μm to 50 μm, refractive index: 1.53, positive birefringence).

(4) λ/4 retardation film: Acrylic (PMMA) film (OKURA Co., Ltd., Japan, with a wavelength of 550 nm, Re: 130 nm to 150 nm, Rth: −100 nm to −130 nm, Nz: 1.48 to 1.50, thickness: 45 μm to 55 μm, refractive index: 1.45, negative birefringence).

(5) Adhesive layer: (Meth)acrylic adhesive.

### Examples 1 and 2

A polarizer was prepared by dyeing a typical material used for polarizers (polyvinyl alcohol film), followed by elongating the material, etc. Specifically, after the polyvinyl alcohol film was elongated to a length of double an initial length of the film at 50° C., iodine was adsorbed onto the elongated polyvinyl alcohol film, and the film was then elongated to a length of 2.5 times its length in a boric acid solution at 40° C., resulting in the formation of the polarizer having a thickness of 22 μm.

A protective film and a λ/2 retardation film were stacked on upper and lower sides, respectively, of the polarizer via a bonding agent (Z-320, Daiichi Kigenso Kagaku Kogyo Co., Ltd.). Using adhesives each having a refractive index as listed in Table 1 (below), a λ/4 retardation film was stacked on a lower side of the λ/2 retardation film, resulting in the formation of the polarizing plate. The adhesive layer had a thickness of 15 μm.

### Comparative Examples 1 and 2

A polarizing plate was prepared in the same manner as describe above with regards to EXAMPLES 1 and 2, except that the refractive index of the adhesive layer was modified as shown in Table 1 (below).

### Comparative Example 3

A polarizing plate was prepared in the same manner as described above with regards to EXAMPLES 1 and 2, except that a λ/2 retardation film was used instead of the λ/4 retardation film.

Organic light emitting diodes were assembled using the polarizing plates prepared in EXAMPLES 1 and 2 and COMPARATIVE EXAMPLES 1 and 2, and evaluated as to the following properties (results are shown in Table 1, below).

(1) Transmittance (Ts) and Degree of polarization (P.E): Transmittance (Ts) and degree of polarization (P.E) were measured on each of the prepared polarizing plates using a V-7100 (JASCO Co., Ltd., Japan).

(2) Reflective brightness and Color shift (Δa*b*): Change in reflective brightness and color at a lateral angle of 65° were measured using an EZ-contrast 3D tester (Eldim Co., Ltd., France).

TABLE 1

| | Refractive | Trans- | | | |
|---|---|---|---|---|---|
| | Index of | mit- | Degree of | Reflective | |
| | Adhesive | tance | Polarization | Brightness | Color |
| | Layer | Ts (%) | P.E. (%) | (%) | Shift |
| EXAMPLE 1 | 1.49 | 45.8 | 99.991 | 17.8 | 9.4 |
| EXAMPLE 2 | 1.51 | 45.8 | 99.990 | 17.9 | 9.4 |
| COMPARATIVE | 1.58 | 45.0 | 99.980 | 17.9 | 9.5 |
| EXAMPLE 1 | | | | | |
| COMPARATIVE | 1.30 | 45.0 | 99.970 | 17.9 | 9.5 |
| EXAMPLE 2 | | | | | |
| COMPARATIVE | 1.49 | 44.9 | 99.979 | 18.7 | 10.3 |
| EXAMPLE 3 | | | | | |

As shown in Table 1, the polarizing plates according to embodiments of the present invention exhibited good front visibility and lateral brightness, and good optical properties such as transmittance and degree of polarization. Thus, the polarizing plates 45, 100 according to aspects of the present invention can reduce reflection of external light and deterioration in front visibility, and increase lateral brightness and optical properties.

Conversely, the polarizing plates of COMPARATIVE EXAMPLES 1 to 2, in which the adhesive layer had a refractive index out of the range between the refractive index of the λ/2 and λ/4 retardation films, exhibited poor transmittance and degree of polarization. In addition, although the polarizing plate of COMPARATIVE EXAMPLE 3, in which two λ/2 retardation films having the same refractive index were stacked, exhibited good front visibility and lateral brightness, the polarizing plate of COMPARATIVE EXAMPLE 3 exhibited poor transmittance and degree of polarization.

It should be understood that various modifications, changes, alterations, and equivalent embodiments can be made by those skilled in the art without departing from the spirit and scope of the invention.

What is claimed is:

1. A polarizing plate comprising:
a polarizer;
a protective film on an upper surface of the polarizer;
a half-wavelength (λ/2) retardation film on a lower surface of the polarizer;
an adhesive layer on a lower surface of the half-wavelength (λ/2) retardation film; and
a quarter-wavelength (λ/4) retardation film on a lower surface of the adhesive layer,
wherein the half-wavelength (λ/2) retardation film has a refractive index n1, the quarter-wavelength (λ/4) retardation film has a refractive index n2, and the adhesive layer has a refractive index n in the range of n1<n<n2 or n2<n<n1.

2. The polarizing plate according to claim 1, wherein the half-wavelength (λ/2) and quarter-wavelength (λ/4) retardation films comprise birefringences of opposite signs.

3. The polarizing plate according to claim 1, wherein the half-wavelength (λ/2) retardation film has a positive (+) birefringence and the quarter-wavelength (λ/4) retardation film has a negative (−) birefringence.

4. The polarizing plate according to claim 1, wherein the refractive index of the half-wavelength (λ/2) retardation film n1 ranges from approximately 1.50 to approximately 1.55, and the refractive index of the quarter-wavelength (λ/4) retardation film n2 ranges from approximately 1.45 to approximately 1.55.

5. The polarizing plate according to claim 1, wherein the refractive index of the adhesive layer n ranges from approximately 1.46 to approximately 1.52.

6. The polarizing plate according to claim 1, wherein each of the half-wavelength (λ/2) and quarter-wavelength (λ/4) retardation films has a phase difference ranging from approximately 0 nanometers to approximately 300 nanometers at a wavelength of 550 nanometers.

7. The polarizing plate according to claim 1, wherein the half-wavelength (λ/2) retardation film has an out-of-plane retardation ranging from approximately 220 nanometers to approximately 240 nanometers at a wavelength of 550 nanometers, and the quarter-wavelength (λ/4) retardation film has an out-of-plane retardation ranging from approximately −100 nanometers to approximately −130 nanometers at a wavelength of 550 nanometers,
wherein the out-of-plane retardation (Rth) is calculated using the formula Rth=((nx+ny)/2−nz)×d, wherein nx, ny, and nz are refractive indexes in x-, y-, and z-axis directions of each retardation film, and d is a thickness of the retardation film.

8. The polarizing plate according to claim 1, wherein the half-wavelength (λ/2) and quarter-wavelength (λ/4) retardation films each comprise a cycloolefin polymer (COP), acrylic, and/or cellulose film.

9. The polarizing plate according to claim 1, wherein a relationship between an angle of an optical axis of the half-wavelength (λ/2) and an angle of an optical axis of the quarter-wavelength (λ/4) retardation films is calculated using the formula θ_{λ/4}=2×θ_{λ/2}+45°, wherein θ_{λ/4} is an angle of an optical axis of the quarter-wavelength (λ/4) retardation film, θ_{λ/2} is an optical axis of the half-wavelength (λ/2) retardation film, and the angles θ_{λ/2} and θ_{λ/4} are measured from a point of reference including an absorption axis or a transmission axis of the polarizer.

10. The polarizing plate according to claim 1, wherein each of the half-wavelength (λ/2) and quarter-wavelength (λ/4) retardation films has a thickness ranging from approximately 10 micrometers to approximately 100 micrometers.

11. The polarizing plate according to claim 1, wherein the adhesive layer comprises a (meth)acrylic copolymer resin and a curing agent.

12. The polarizing plate according to claim 1, further comprising a functional layer on an upper surface of the protective film.

13. The polarizing plate according to claim 1, further comprising an adhesive layer having a refractive index ranging from approximately 1.48 to approximately 1.55 on a lower surface of the quarter-wavelength (λ/4) retardation film.

14. A polarizing plate comprising:
a polarizer;
a protective film on an upper surface of the polarizer;
a half-wavelength (λ/2) retardation film on a lower surface of the polarizer; and
a quarter-wavelength (λ/4) retardation film on a lower surface of the half-wavelength (λ/2) retardation film,
wherein the half-wavelength (λ/2) and quarter-wavelength (λ/4) retardation films comprise birefringences of opposite signs.

15. The polarizing plate according to claim 14, wherein the half-wavelength (λ/2) retardation film has a positive (+) birefringence and the quarter-wavelength (λ/4) retardation film has a negative (−) birefringence.

16. The polarizing plate according to claim 14, further comprising an adhesive layer between the half-wavelength (λ/2) retardation film and the quarter-wavelength (λ/4) retardation film.

17. The polarizing plate according to claim 16, wherein the half-wavelength (λ/2) retardation film has a refractive index n1, the quarter-wavelength (λ/4) retardation film has a refractive index n2, and the adhesive layer has a refractive index n in the range of n1<n<n2 or n2<n<n1.

18. An optical display apparatus comprising:
a polarizing plate;
a window on a top surface of the polarizing plate;
a conductor on a bottom surface of the polarizing plate;
an optical display device on a bottom surface of the conductor; and
a substrate on a bottom surface of the optical display device,
wherein the polarizing plate comprises a polarizer, a half-wavelength (λ/2) retardation film on a lower surface of the polarizer, and a quarter-wavelength (λ/4) retardation film on a lower surface of the half-wavelength (λ/2) retardation film.

19. The optical display apparatus according to claim 18, wherein the apparatus is an organic light emitting diode (OLED) display apparatus.

20. The optical display apparatus according to claim 18, wherein the polarizing plate further comprises:
a protective film on an upper surface of the polarizer; and
an adhesive layer on a lower surface of the half-wavelength (λ/2) retardation film,
wherein the half-wavelength (λ/2) retardation film has a refractive index n1, the quarter-wavelength (λ/4) retardation film has a refractive index n2, and the adhesive layer has a refractive index n in the range of n1<n<n2 or n2<n<n1.
